(19) United States
(12) Patent Application Publication
(10) Pub. No.: US 2026/0028510 A1
(43) Pub. Date: Jan. 29, 2026

(54) METHOD FOR MANUFACTURING LAMINATE

(71) Applicant: KANEKA CORPORATION, Osaka (JP)

(72) Inventor: Toshihiko Okamoto, Hyogo (JP)

(73) Assignee: KANEKA CORPORATION, Osaka (JP)

(21) Appl. No.: 19/342,953

(22) Filed: Sep. 29, 2025

Related U.S. Application Data
(63) Continuation of application No. PCT/JP2024/008925, filed on Mar. 8, 2024.

(30) Foreign Application Priority Data
Mar. 30, 2023 (JP) 2023-056684

(51) Int. Cl. C09J 163/00; C09J 5/06; C09J 11/08

(52) U.S. Cl. CPC C09J 163/00; C09J 5/06; C09J 11/08; C09J 2203/354; C09J 2400/166

(57) ABSTRACT

A method for producing a laminate that is obtained by bonding an adherend with a cured product having a high elastic modulus in a high-temperature environment even in a case where low-temperature curing is carried out, is provided. The method for producing a laminate includes the steps of applying a curable resin composition having a specific composition to a first adherend and bonding the first adherend with a second adherend, and subjecting the curable resin composition to low-temperature curing. The laminate has a ratio of a thickness of the cured product and an average thickness of those adherends in a specific range.

### TECHNICAL FIELD

One or more embodiments of the present invention relate to a method for producing a laminate.

### BACKGROUND

A curable resin composition containing an epoxy resin is excellent in many aspects, such as dimensional stability, mechanical strength, electrical insulation properties, heat resistance, water resistance, and chemical resistance, and is used in various applications.

A structural adhesive for automobiles is known as an example of an application of the curable resin composition containing an epoxy resin. Patent Literatures 1 and 2 disclose a technology related to curable resin compositions containing an epoxy resin.

### PATENT LITERATURE

### [Patent Literature 1]

Japanese Patent Application Publication Tokukai No. 2019-038926

### [Patent Literature 2]

PCT International Publication No. WO 2018/156450

### SUMMARY

However, in a conventional curable resin composition as disclosed in Patent Literatures 1 and 2, an elastic modulus of a cured product in a resultant laminate, in particular, the elastic modulus at a high temperature significantly lowers, in a case where the curable resin composition is cured at a low temperature in a short time when an adherend is bonded with use of the curable resin composition.

In view of the above current circumstances, a laminate that is obtained by bonding an adherend with use of a cured product which has a high elastic modulus in a high-temperature environment even in a case where curing is carried out at a low temperature in a short time, is provided.

As a result of conducting diligent studies, the inventors of one or more embodiments of the present invention have completed one or more embodiments of the present invention.

In other words, one or more embodiments of the present invention are a method for producing a laminate in which a first adherend, a cured product obtained by curing a curable resin composition, and a second adherend are layered in this order, the method including the steps of: (i) applying the curable resin composition to the first adherend and bonding the second adherend with the first adherend (bonding step); and (ii) curing the curable resin composition (curing step), the curable resin composition containing an epoxy resin (A), and dicyandiamide (B) in an amount of 3.5 parts by mass to 19.0 parts by mass with respect to 100 parts by mass of the epoxy resin (A), the epoxy resin (A) containing an unmodified bisphenol A epoxy resin (A-1) in an amount of 51% by mass to 100% by mass in 100% by mass of a total amount of the epoxy resin (A), in step (ii), the curable resin composition being cured at a curing temperature of 105° C. to 145° C., in step (ii), the curable resin composition being cured for a curing time of 10 minutes to 60 minutes, and a thickness (Y) of the cured product and an average thickness (X) of the first adherend and the second adherend being at a ratio (Y/X) of 0.5 to 10.0.

One or more embodiments of the present invention can provide a laminate that is obtained by bonding an adherend with use of a cured product which has a high elastic modulus in a high-temperature environment even in a case where curing is carried out at a low temperature in a short time.

### DETAILED DESCRIPTION

The following description will discuss embodiments of the present invention. One or more embodiments of the present invention are not, however, limited to these embodiments. One or more embodiments of the present invention are not limited to the configurations described below, but may be altered in various ways within the scope of the claims. Any embodiment or Example derived by combining technical means disclosed in differing embodiments and Examples is also encompassed in the technical scope of the present invention. All academic and patent documents cited in the present specification are incorporated herein by reference. Unless otherwise specified in the present specification, any numerical range expressed as “A to B” is intended to mean “not less than A and not more than B”.

### 1. Technical Idea of One or More Embodiments of the Present Invention

Due to recent movement for dealing with carbon neutrality, there are needs for decreasing a temperature in a baking furnace for electrodeposition (undercoat paint for rust prevention of automobiles). On this account, a conventional baking temperature of 170° C. to 190° C. at electrodeposition has been decreased to approximately 120° C. to 145° C. Further, there is also a demand for shortening a baking time (to not more than 60 minutes).

In a production process of automobiles, normally, an automobile structural adhesive is cured simultaneously with the electrodeposition paint in the baking furnace. Accordingly, also for the structural adhesive, there is a demand for curing at a lower temperature (not more than 145° C.) in a shorter time.

Further, the automobile structural adhesive is required to have a high elastic modulus not only in a normal environment (for example, in a room temperature environment) but also in a high-temperature environment during summer or the like.

However, it has been found that in a conventional curable resin composition as disclosed in Patent Literatures 1 and 2, a resultant cured product has a low Tg in a case where the curable resin composition is cured at a low temperature in a short time. As a result, (a) a cured product that is obtained by bonding an adherend with use of the curable resin composition, and (b) a laminate including the cured product, have a low elastic modulus in a high-temperature environment.

In the above circumstances, the inventors of one or more embodiments of the present invention made diligent studies in order to provide a laminate that is obtained by bonding an adherend with use of a cured product which has a high elastic modulus in a high-temperature environment even in a case where curing is carried out at a low temperature in a short time. In the studies, the inventors of one or more embodiments of the present invention have obtained novel findings. According to the novel findings, there is a correlation between a glass transition temperature (hereinafter may be referred to as “Tg”) of a cured product obtained by curing a curable resin composition at a low temperature in a short time and a ratio (Y/X) between a thickness (Y) of the cured product and an average thickness (X) of an adherend bonded with use of the cured product. As a result of further making diligent studies based on the novel findings, the inventors of one or more embodiments of the present invention have found that it is possible to provide a laminate that is obtained by bonding an adherend with use of a cured product which has a high elastic modulus in a high-temperature environment even in a case where curing is carried out at a low temperature in a short time, by (1) using a curable resin composition having specific composition and (2) controlling, within a specific range, a ratio (Y/X) between a thickness (Y) of the cured product obtained by curing the curable resin composition and the average thickness (X) of the adherend with use of the cured product.

A technique for bonding (making a laminate with) an adherend with use of a cured product which has a high elastic modulus in a high-temperature environment even in a case where curing is carried out at a low temperature in a short time has not been conventionally known. Thus, the technique is surprising. Further, such a method for producing a laminate is very useful, particularly in production of a vehicle body structure of an automobile.

### 2. Method for Producing Laminate

A method in accordance with one or more embodiments of the present invention for producing a laminate is a method for producing a laminate in which a first adherend, a cured product obtained by curing a curable resin composition, and a second adherend are layered in this order, the method including the steps of: (i) applying the curable resin composition to the first adherend and bonding the second adherend with the first adherend (bonding step); and (ii) curing the curable resin composition (curing step), the resin composition containing an epoxy resin (A), and dicyandiamide (B) in an amount of 3.5 parts by mass to 19.0 parts by mass with respect to 100 parts by mass of the epoxy resin (A), the epoxy resin (A) containing an unmodified bisphenol A epoxy resin (A-1) in an amount of 51% by mass to 100% by mass, in step (ii), the curable resin composition being cured at a curing temperature of 105° C. to 145° C., in step (ii), the curable resin composition being cured for a curing time of 10 minutes to 60 minutes, and a thickness (Y) of the cured product obtained by curing the curable resin composition and an average thickness (X) of the first adherend and the second adherend being at a ratio (Y/X) of 0.5 to 10.0. In the following description, the “method for producing a laminate in accordance with one or more embodiments of the present invention” may be referred to as the “present production method”, the “epoxy resin (A)” may be referred to as a “component (A)”, and the “dicyandiamide (B)” may be referred to as a “component (B)”.

The present production method can provide a laminate that is obtained by bonding an adherend with use of a cured product which has a high elastic modulus in a high-temperature environment even in a case where curing is carried out at a low temperature in a short time.

### [2-1. Curable Resin Composition]

The following description will discuss in detail a curable resin composition that is used in the present production method. The curable resin composition in accordance with one or more embodiments of the present invention (hereinafter may be referred to as the “present curable resin composition”) contains, with respect to 100 parts by mass of a component (A), 3.5 parts by mass to 19.0 parts by mass of a component (B). It is possible to obtain a cured product by curing the present curable resin composition by a method described later in “Curing Step”.

The following description will discuss in detail each component that may be contained in the present curable resin composition.

### <Epoxy Resin (A)>

In the present specification, the epoxy resin is intended to mean a resin that may have, in a molecule, at least one epoxy group or two or more epoxy groups. Examples of the epoxy resin which the present curable resin composition can contain as the component (A) encompass unmodified bisphenol A epoxy resins (A-1) (hereinafter may be referred to as “component (A-1)”), unmodified bisphenol F epoxy resin (A-2) (hereinafter may be referred to as “component (A-2)”), aliphatic polybasic acid-modified epoxy resin (A-3) (hereinafter may be referred to as “component (A-3)”), and another epoxy resin(s) (other than the components (A-1) to (A-3)). In the present specification, the component (A) is intended to mean a generic term for these epoxy resins that are contained in the present curable resin composition. For example, in the present specification, an amount of the component (A) is intended to mean the total amount of the component (A-1), the component (A-2), the component (A-3), and another epoxy resin(s), which is contained in the present curable resin composition. It can also be said that the component (A) is a curable resin.

A content of the component (A) in the present curable resin composition is not particularly limited, but the content may be 20% by mass to 80% by mass, 25% by mass to 75% by mass, or 35% by mass to 55% by mass, in the total amount, that is, 100% by mass of the present curable resin composition. In a case where the content of the component (A) in the present curable resin composition is not less than 20% by mass, there is an advantage in that a resultant cured product has excellent strength and excellent adhesive strength. On the other hand, in a case where the content of the component (A) in the present curable resin composition is not more than 80% by mass, there is an advantage in that a resultant cured product has excellent workability.

### (Unmodified Bisphenol A Epoxy Resin (A-1))

The component (A) contains 51% by mass to 100% by mass of the component (A-1) in 100% by mass of the total amount of the component (A). A content of the component (A-1) in the component (A) is 51% by mass to 100% by mass, 55% by mass to 90% by mass, or 60% by mass to 80% by mass, in 100% by mass of the total amount of the component (A). In a case where the content of the component (A-1) in the component (A) contained in the present curable resin composition is in the above range, it is possible to provide a cured product that has an excellent elastic modulus in a high-temperature environment. An epoxy equivalent weight of the component (A-1) is not particularly limited, but may be 150 to 1000, 160 to 500, or 170 to 200. In a case where the epoxy equivalent weight of the component (A-1) is not less than 150, a resultant cured product is likely have improved adhesive strength and improved rigidity. On the other hand, in a case where the epoxy equivalent weight of the component (A-1) is not more than 1000, handleability of the curable resin composition is likely to be improved.

In the present specification, the epoxy equivalent weight is intended to mean a molecular weight per epoxy group that is contained in a compound having an epoxy group, and is specifically a value obtained by calculation based on the following expression:

$$Epoxy equivalent weight ( g / eq ) = mass average molecular weight ( Mw ) of compound / number of epoxy groups per molecule of compound ( average number ) .$$

Note that the epoxy equivalent weight can also be measured in accordance with JIS K 7236.

Examples of a commercially available component (A-1) include, but are not limited to: products which are commercially available from Mitsubishi Chemical Corporation and which have a brand name jER (for example, jER828, jER825, jER827, jER828EL, jER828US, jER828XA, jER834, jER1001, jER1002, jER1004, jER1007, jER1009, and jER1010); products which are commercially available from Momentive Specialty Chemicals, Inc. and which have a brand name EPON (for example, EPON 1510, EPON 1310, EPON 828, EPON 872, EPON 1001, EPON 1004, and EPON 2004), products which are commercially available from Olin Epoxy Co. and which have a brand name DER (for example, DER 331, DER 332, DER 336, and DER 439); products which are commercially available from ADEKA Corporation and which have a brand name ADEKA RESIN (for example, EP-4100, EP-4300, EP-4400, EP-4530, and EP-4504); and products which are commercially available from DIC Corporation and which have a brand name EPICLON (for example, EPICLON 840 and EPICLON 850).

### (Unmodified Bisphenol F Epoxy Resin (A-2))

The component (A) may contain a component (A-2) in addition to the component (A-1). In a case where the present curable resin composition contains the component (A-2) as the content (A), a content of the component (A-2) in the component (A) may be 1% by mass to 80% by mass, 5% by mass to 50% by mass, or 10% by mass to 30% by mass in 100% by mass of the total amount of the component (A). In a case where the component (A) contained in the present curable resin composition contains the component (A-2) in the above range, it is possible to provide a curable resin composition which has a low viscosity and excellent workability and with which a resultant cured product has excellent toughness and excellent adhesive strength.

An epoxy equivalent weight of the component (A-2) is not particularly limited, but may be 150 to 1000, 160 to 500, or 170 to 200. In a case where the epoxy equivalent weight of the component (A-2) is not less than 150, a resultant cured product advantageously has excellent adhesive strength and excellent high-temperature rigidity. On the other hand, in a case where the epoxy equivalent weight of the component (A-2) is not more than 1000, the handleability of the curable resin composition improves. Thus, an equivalent weight of 150 to 1000 is preferable.

Examples of a commercially available component (A-2) include, but are not limited to: products which are commercially available from Mitsubishi Chemical Corporation and which have the brand name jER (for example, jER806, jER806H, jER807, jER4005P, jER4007P, and jER4010P); products which are commercially available from Olin Epoxy Co. and which have the brand name DER (for example, DER 334); products which are commercially available from ADEKA Corporation and which have the brand name ADEKA RESIN (for example, EP-4901 and EP-4901E); and products which are commercially available from DIC Corporation and which have the brand name EPICLON (for example, EPICLON 830).

### (Aliphatic Polybasic Acid-Modified Epoxy Resin (A-3))

The present curable resin composition may contain a component (A-3) as a component (A). In a case where the present curable resin composition contains the component (A-3) as the component (A), a content of the component (A-3) in the component (A) may be more than 0% by mass and less than 3.0% by mass, more than 0% by mass and not more than 2.0% by mass, or more than 0% by mass and not more than 1.0% by mass, in 100% by mass of the component (A). The content of the component (A-3) in the component (A) may be 0% by mass. In other words, the present curable resin composition may not contain the component (A-3) as the component (A). The present curable resin composition may contain, as the component (A), (1) no component (A-3) or (2) more than 0% by mass and less than 3.0% by mass of the component (A-3) in 100% by mass of the component (A), since it is possible to provide a curable resin composition with which a resultant cured product has a better elastic modulus in a high-temperature environment.

In the specification, present the aliphatic polybasic acid-modified epoxy resin is intended to mean a compound that can be obtained by subjecting aliphatic polybasic acid or the like to an addition reaction with an epoxy resin.

Examples of the aliphatic polybasic acid that is subjected to an addition reaction with the epoxy resin encompass, but are not limited to: unsaturated polyvalent carboxylic acids that do not have an aromatic ring or anhydrides thereof, such as maleic acid, maleic anhydride, fumaric acid, itaconic acid, itaconic anhydride, and citraconic acid; and saturated polyvalent carboxylic acids that do not have an aromatic ring or anhydrides thereof, such as tetrahydrophthalic acid, tetrahydrophthalic anhydride, hexahydrophthalic acid, hexahydrophthalic anhydride, cyclohexanedicarboxylic acid, succinic acid, malonic acid, glutaric acid, adipic acid, azelaic acid, sebacic acid, 1,12-dodecanedioic acid, dimer acid, and trimer acid. The aliphatic polybasic acid can be a generally used aliphatic polybasic acid. Particularly, dimer acid is preferable because a resulting cured product has excellent damping properties.

In the present specification, the “dimer acid” is intended to mean a dimerized product of an unsaturated fatty acid having 18 carbon atoms. Examples of the fatty acid having 18 carbon atoms encompass oleic acid, linoleic acid, and linolenic acid.

The epoxy resin with which the above aliphatic polybasic acid or the like is subjected to an addition reaction can be any of various epoxy resins. Examples of the epoxy resin encompass, but are not limited to, bisphenol A epoxy resin, bisphenol F epoxy resin, bisphenol AD epoxy resin, bisphenol S epoxy resin, glycidyl ester type epoxy resin, glycidyl amine type epoxy resin, novolac type epoxy resin, glycidyl ether type epoxy resin of bisphenol A propylene oxide adduct, hydrogenated bisphenol A (or F) epoxy resin, fluorinated epoxy resin, flame-resistant epoxy resin such as glycidyl ether of tetrabromo bisphenol A, p-oxybenzoic acid glycidyl ether ester type epoxy resin, m-aminophenol type epoxy resin, diaminodiphenylmethane-based epoxy resin, various types of alicyclic epoxy resin, N, N-diglycidyl aniline, N, N-diglycidyl-o-toluidine, triglycidyl isocyanurate, divinylbenzene dioxide, resorcinol diglycidyl ether, polyalkylene glycol diglycidyl ether, and glycol diglycidyl ether. The epoxy resin can be a generally used epoxy resin.

The component (A-3) is not particularly limited, provided that the component (A-3) is an adduct between any of the above aliphatic polybasic acids and any of the above epoxy resins. Specific examples of the component (A-3) encompass dimer acid-modified epoxy resins, hydrogenated dimer acid-modified epoxy resins, and trimer acid-modified epoxy resins. The component (A-3) may be a dimer acid-modified epoxy resin, which is an adduct between a dimer (dimer acid) of toll oil fatty acid and a bisphenol A epoxy resin, as disclosed in International Publication No. 2010-098950, since there are advantages in that such an adduct is easy to obtain and in that a resultant cured product has excellent damping properties. As the component (A-3), one type of the above compounds may be used alone, or two or more types of the above compounds may be used in combination.

The component (A-3) may contain a dimer acid-modified epoxy resin because the dimer acid-modified epoxy resin is easy to obtain and a resultant cured product has better damping properties. The present curable resin composition may contain a dimer acid-modified epoxy resin in an amount of not less than 80% by mass, not less than 90% by mass, not less than 95% by mass, or 100% by mass, in 100% by mass of the total amount of the component (A-3), because the dimer acid-modified epoxy resin is easy to obtain and a resulting cured product has better damping properties.

An epoxy equivalent weight of the component (A-3) is not particularly limited, but may be 250 to 800, 300 to 700, or 380 to 500. In a case where the epoxy equivalent weight of the component (A-3) is not less than 250, a resultant cured product advantageously has excellent damping properties. On the other hand, in a case where the epoxy equivalent weight of the component (A-3) is not more than 800, the handleability of a resultant curable resin composition improves. Thus, an epoxy equivalent weight of 250 to 800 is preferable.

### (Another Epoxy Resin(s))

The present curable resin composition may contain another epoxy resin (other epoxy resins) other than the above components (A-1) to (A-3). Examples of the other epoxy resin(s) encompass, but are not limited to, rubber-modified epoxy resin, bisphenol AD epoxy resin, bisphenol S epoxy resin, glycidyl ester type epoxy resin, glycidyl amine type epoxy resin, novolac type epoxy resin, glycidyl ether type epoxy resin of bisphenol A propylene oxide adduct, hydrogenated bisphenol A (or F) epoxy resin, fluorinated epoxy resin, flame-resistant epoxy resin such as glycidyl ether of tetrabromo bisphenol A, p-oxybenzoic acid glycidyl ether ester type epoxy resin, m-aminophenol type epoxy resin, diaminodiphenylmethane-based epoxy resin, various types of alicyclic epoxy resin, N, N-diglycidyl aniline, N, N-diglycidyl-o-toluidine, triglycidyl isocyanurate, divinylbenzene dioxide, resorcinol diglycidyl ether, polyalkylene glycol diglycidyl ether, glycol diglycidyl ether, diglycidyl ester of aliphatic polybasic acid, glycidyl ether of a polyvalent aliphatic alcohol having bivalency or greater valency such as glycerin, chelate-modified epoxy resin, urethane-modified epoxy resin, hydantoin-type epoxy resin, an epoxidized unsaturated polymer such as petroleum resin, amino-containing glycidyl ether resin, and an epoxy compound obtained by subjecting a bisphenol A (or F), a polybasic acid, or the like to an addition reaction with the above epoxy resin. The other epoxy resin(s) can be a generally used epoxy resin.

In a case where the present curable resin composition contains another epoxy resin(s) as the component (A), the content of the other epoxy resin(s) in the component (A) is not particularly limited. However, the content of the other epoxy resin(s) may be 0.0% by mass to 20.0% by mass, 0.1% by mass to 10.0% by mass, or 1.0% by mass to 5.0% by mass, with respect to 100% by mass of the component (A).

### <Dicyandiamide (B)>

The present curable resin composition contains a component (B). In the present curable resin composition, dicyandiamide, which is the component (B), can function as a curing agent that cures the curable resin composition. At a temperature of at least lower than 100° C., the dicyandiamide does not exhibit a curing action or causes a curing reaction to progress very slowly even if the dicyandiamide exhibits the curing action. On the other hand, in a case where the dicyandiamide heated to a temperature of not lower than 100° C. (preferably a temperature of 120° C.), the dicyandiamide exhibits a quick curing action and can quickly cure a curable resin composition. Having such a physical property, the dicyandiamide may be referred to as a latent curing agent.

The present curable resin composition may contain the component (B) in an amount of 3.5 parts by mass to 19.0 parts by mass, 3.5 parts by mass to 18.0 parts by mass, 4.0 parts by mass to 16.0 parts by mass, 4.5 parts by mass to 14.0 parts by mass, 5.0 parts by mass to 12.0 parts by mass, 5.5 parts by mass to 10.0 parts by mass, or 6.0 parts by mass to 8.0 parts by mass, with respect to 100 parts by mass of the component (A). In a case where the content of the component (B) in the present curable resin composition is not less than (1) 3.5 parts by mass with respect to 100 parts by mass of the component (A), there is an advantage in that a cured product obtained by curing the present curable resin composition at a low temperature has sufficient adhesive strength. On the other hand, in (b) a case where the content of the component (B) is not more than 19.0 parts by mass with respect to 100 parts by mass of the component (A), there is an advantage in that the present curable resin composition has favorable storage stability and also in that a resultant cured product has preferable moist heat resistance.

### <Polymer Particles (C) Having Core-Shell Structure>

The present curable resin composition may contain, in addition to the above components (A) and (B), polymer particles (C) (hereinafter may be referred to as “component (C)”) that have a core-shell structure. In a case where the present curable resin composition contains (C), is the component it advantageously possible to provide a cured product (for example, an adhesive layer) that has excellent impact-peel-resistant adhesiveness and excellent adhesive strength.

In the present specification, the polymer particles having a core-shell structure are intended to mean particles in which a core layer consisting of a core polymer and a shell layer consisting of a shell polymer form a multilayer structure.

The component (C) is not particularly limited in structure, provided that the component (C) has at least one core layer and at least one shell layer. The component (C) can also have a structure that have three or more layers and that includes a core layer, an intermediate layer covering the core layer, and a shell layer covering the intermediate layer. Further, in the component (C), the core layer and the shell layer may not form a complete multilayer structure. That is, the shell layer only needs to cover at least part of the core layer and may not cover the whole of the core layer. Alternatively, part of the shell polymer which constitutes the shell layer may enter the core layer.

In the component (C), it is preferable that the shell polymer and the core polymer be substantially chemically bonded (for example, graft-bonded) to each other. The component (C) may be core shell polymer particles which are obtained by forming a shell layer by graft polymerization of a graft copolymerizable monomer (shell monomer) to the core layer (core polymer) in the presence of the core layer. Such an polymerization operation can be carried out, for example, by: adding a shell monomer to core polymer latex that has been prepared and that exists in the form of an aqueous polymer latex; and then carrying out polymerization. The component (C) obtained by such an operation can have a structure that includes a core layer which is present inside the component (C) and at least one shell layer which is graft polymerized to the surface of the core layer and which entirely or partially covers the core layer.

The following description will specifically discuss each layer which the component (C) may contain.

### <<Core Layer>>

The core layer which the component (C) has, may be an elastic core layer that has properties as a rubber, in order to increase the toughness of a cured product of a composition.

The core layer may contain a diene-based rubber in that such a core layer (i) has a large effect of improving the toughness of a resulting cured product, (ii) has a large effect of improving the impact-peel-resistant adhesiveness of a resulting cured product, and (iii) has a low affinity with the component (A), which makes it difficult for viscosity to increase with time due to swelling of the core layer. The core layer may contain a (meth)acrylate-based rubber in that such a core layer enables design of polymers of a wide variety of compositions by combination of a plurality of monomers. In a case where it is desirable to enhance impact resistance at low temperatures without decreasing the heat resistance of the cured product, the core layer may contain an organosiloxane-based rubber. In other words, the core layer may contain at least one type selected from the group consisting of diene-based rubbers, (meth)acrylate-based rubbers, and organosiloxane-based rubbers.

### (Diene-Based Rubber)

The diene-based rubber may be a polymer that contains a structural unit derived from at least one monomer selected from the group consisting of conjugated diene-based monomers (hereinafter also referred to as conjugated diene-based unit) in an amount of 50% by mass to 100% by mass and a structural unit derived from a vinyl-based monomer which differs from the conjugated diene-based monomers and which is copolymerizable with the conjugated diene-based monomers in an amount of 0% by mass to 50% by mass.

Examples of the conjugated diene-based monomer encompass 1,3-butadiene, isoprene (2-methyl-1,3-butadiene), and 2-chloro-1,3-butadiene.

One type of these conjugated diene-based monomers may be used alone, or two or more types of these conjugated diene-based monomers may be used in combination.

A content of the conjugated diene-based unit in the core layer may be 50% by mass to 100% by mass, 70% by mass to 100% by mass, or 90% by mass to 100% by mass, in 100% by mass of all of the structural units that constitute the core layer. Setting the content of the conjugated diene-based unit in the core layer to not less than 50% by mass makes it possible for a resulting cured product to have more favorable impact-peel-resistant adhesiveness.

Examples of the vinyl-based monomer which differs from the conjugated diene-based monomers and which is copolymerizable with the conjugated diene-based monomers encompass: vinyl arenes such as styrene, α-methylstyrene, monochlorostyrene, and dichlorostyrene; vinyl carboxylic acids such as acrylic acid and methacrylic acid; vinyl cyanides such as acrylonitrile and methacrylonitrile; halogenated vinyls such as vinyl chloride, vinyl bromide, and chloroprene; vinyl acetate; alkenes such as ethylene, propylene, butylene, and isobutylene; and polyfunctional monomers such as diallyl phthalate, triallyl cyanurate, triallyl isocyanurate, and divinylbenzene.

One type of these vinyl-based monomers may be used alone, or two or more types of these vinyl-based monomers may be used in combination. Styrene is particularly preferable.

It is more preferable that the core layer contain, among diene-based rubbers, butadiene rubber which is a homopolymer of 1,3-butadiene and/or butadiene-styrene rubber which is a copolymer of 1,3-butadiene and styrene, in that such a core layer (i) has a larger effect of improving the toughness of a resulting cured product, (ii) has a larger effect of improving the impact-peel-resistant adhesiveness of a resulting cured product, and (iii) has a low affinity with the component (A), which makes it more difficult for viscosity to increase with time due to swelling of the core layer. In terms of these effects, it is more preferable that the core layer be (consist only of) butadiene rubber and/or butadiene-styrene rubber, it is even more preferable that the core layer contain butadiene rubber, and it is particularly preferable that the core layer be (consist only of) butadiene rubber. Further, butadiene-styrene rubber is preferable in that butadiene-styrene rubber makes it possible to increase the transparency of the resulting cured product by adjustment of a refractive index.

### ((Meth)Acrylate-Based Rubber)

The (meth)acrylate-based rubber may be a polymer that is obtained by polymerizing a monomer mixture which contains a structural unit derived from at least one monomer selected from the group consisting of (meth)acrylate-based monomers (hereinafter also referred to as (meth)acrylate-based unit) in an amount of 50% by mass to 100% by mass and a structural unit derived from a vinyl-based monomer which differs from the (meth)acrylate-based monomers and which is copolymerizable with the (meth)acrylate-based monomers in an amount of 0% by mass to 50% by mass. Note that, in the present specification, “(meth)acrylate” means acrylate and/or methacrylate.

Examples of the (meth)acrylate-based monomers encompass: (i) alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; (ii) aromatic ring-containing (meth)acrylates such as phenoxyethyl (meth)acrylate and benzyl (meth)acrylate; (iii) hydroxyalkyl (meth)acrylates; (iv) glycidyl (meth)acrylates such as glycidyl (meth)acrylate and glycidyl alkyl (meth)acrylate; (v) alkoxy alkyl (meth)acrylates; (vi) allyl alkyl (meth)acrylates such as allyl (meth)acrylate and allyl alkyl (meth)acrylate; and (vii) polyfunctional (meth)acrylates such as monoethylene glycol di(meth)acrylate, triethylene glycol di(meth)acrylate, and tetraethylene glycol di(meth)acrylate.

Examples of the hydroxyalkyl (meth)acrylates encompass: hydroxy straight-chain alkyl (meth)acrylates (particularly, hydroxy straight chain C₁-C₆ alkyl (meth)acrylates) such as 2-hydroxyethyl (meth)acrylates, hydroxypropyl (meth)acrylates, and 4-hydroxybutyl (meth)acrylates; caprolactone-modified hydroxy (meth)acrylates; hydroxy branching alkyl (meth)acrylates such as α-(hydroxymethyl) methyl acrylates and α-(hydroxymethyl) ethyl acrylates; and hydroxyl-group-containing (meth)acrylates such as mono (meth)acrylates of a polyester diol (particularly, saturated polyester diol) obtained from a dicarboxylic acid (e.g., phthalic acid) and a dihydric alcohol (e.g., propylene glycol).

One type of these (meth)acrylate-based monomers may be used alone, or two or more types of these (meth)acrylate-based monomers may be used in combination. As the (meth)acrylate-based monomer, ethyl (meth)acrylate, butyl (meth)acrylate, and 2-ethylhexyl (meth)acrylate are preferable.

Examples of the vinyl-based monomer which differs from the (meth)acrylate-based monomers and which is copolymerizable with the (meth)acrylate-based monomers encompass: (i) vinyl arenes such as styrene, x-methylstyrene, monochlorostyrene, and dichlorostyrene; (ii) vinyl carboxylic acids such as acrylic acid and methacrylic acid; (iii) vinyl cyanides such as acrylonitrile and methacrylonitrile; (iv) halogenated vinyls such as vinyl chloride, vinyl bromide, and chloroprene; (v) vinyl acetate; (vi) alkenes such as ethylene, propylene, butylene, and isobutylene; and (vii) polyfunctional monomers such as diallyl phthalate, triallyl cyanurate, triallyl isocyanurate, and divinylbenzene.

One type of the examples of the vinyl-based monomer which differs from the (meth)acrylate-based monomers and which is copolymerizable with the (meth)acrylate-based monomers may be used alone, or two or more types of the examples of the vinyl-based monomer which differs from the (meth)acrylate-based monomers and which is copolymerizable with the (meth)acrylate-based monomers may be used in combination. Styrene is particularly preferable in that styrene makes it possible to easily increase a refractive index.

### (Organosiloxane-Based Rubber)

Examples of the organosiloxane-based rubber encompass: (i) polysiloxane-based polymers composed of alkyl or aryl disubstituted silyloxy units, such as dimethylsilyloxy, diethylsilyloxy, methylphenylsilyloxy, diphenylsilyloxy, and dimethylsilyloxy-diphenylsilyloxy; and (ii) polysiloxane-based polymers composed of alkyl or aryl monosubstituted silyloxy units, such as organohydrogensilyloxy in which some of sidechain alkyls have been substituted with hydrogen atoms.

One of these polysiloxane-based polymers may be used alone or two or more of these may be used in combination. Out of these examples, dimethylsilyloxy, methylphenylsilyloxy, and dimethylsilyloxy-diphenylsilyloxy are preferable because they can provide heat resistance to a resultant cured product. Dimethylsilyloxy is most preferable because it can be easily acquired.

In order to increase the toughness of a resulting cured product, the core layer may have a glass transition temperature of not higher than 0° C., not higher than −20° C., not higher than −40° C., or not higher than −60° C.

In addition, the volume-average particle size of the core layer is not particularly limited, but may be 0.03 μm to 2 μm, 0.05 μm to 1 μm, 0.12 μm to 0.50 μm, 0.12 μm to 0.28 μm, or 0.14 μm to 0.25 μm. In a case where the volume-average particle size of the core layer is within this range, it is possible to produce the core layer stably, and a cured product can have favorable heat resistance and favorable impact resistance. A method of measuring the volume-average particle size of the core layer will be described in detail in Examples later.

The core layer may have a single-layer structure. Alternatively, the core layer may have a multilayer structure that includes layers having rubber elasticity. Further, in a case where the core layer has a multilayer structure, the layers may have differing polymer compositions within the scope of the disclosure.

In one or more embodiments of the present invention, for example, an intermediate layer described in paragraphs [0046] to [0049] in the pamphlet of WO 2016/163491 can be provided between the core layer and the shell layer.

### <<Shell Layer>>

The shell layer is a polymer which is made by polymerizing a shell monomer (monomer for shell layer formation). The polymer (shell polymer) constituting the shell layer serves to improve compatibility between the component (C) and the component (A) and enables the component (C) to be dispersed in the form of primary particles in the present curable resin composition and/or in a cured product obtained by curing the present curable resin composition.

As the shell monomer, one type of the above-described monomers may be used alone, or two or more types of the above-described monomers may be used in combination. In a case where the shell monomer includes two or more types of monomers, the composition of the shell monomer, that is, types and content ratio of the monomers contained in the shell monomer are not particularly limited. In terms of compatibility and dispersibility of the component (C) in the curable resin composition, the shell monomer may be an aromatic vinyl-based monomer, a vinyl cyanide-based monomer, or a (meth)acrylate-based monomer, or a (meth)acrylate-based monomer. The shell monomer particularly may contain methyl methacrylate.

In other words, the type and proportion of structural unit included in the shell layer are not particularly limited. In terms of compatibility and dispersibility of the component (C) in the present curable resin composition, the shell layer may contain a structural unit derived from at least one type of monomer selected from the group consisting of aromatic vinyl-based monomers, vinyl cyanide-based monomers, and (meth)acrylate-based monomers, or a structural unit derived from a (meth)acrylate-based monomer. The shell layer particularly may contain a structural unit derived from methyl methacrylate.

A total content of the structural unit derived from at least one type of monomer selected from the group consisting of aromatic vinyl-based monomers, vinyl cyanide-based monomers, and (meth)acrylate-based monomers in the shell layer may be 10.0% by mass to 99.5% by mass, 50.0% by mass to 99.0% by mass, 65.0% by mass to 98.0% by mass, 67.0% by mass to 80.0% by mass, or 67.0% by mass to 85.0% by mass, in 100% by mass of the shell layer (shell polymer).

Specific examples of the aromatic vinyl-based monomers encompass vinylbenzenes such as styrene, α-methylstyrene, p-methylstyrene, and divinylbenzene.

Specific examples of the vinyl cyanide-based monomers encompass acrylonitrile and methacrylonitrile.

Specific examples of the (meth)acrylate-based monomers are the same as those described in the section under <<Core Layer>> above. Therefore, the description in the section under <<Core Layer>> is incorporated and a description of the specific examples of the (meth)acrylate-based monomers will be omitted here.

From the viewpoint of chemically bonding the component (C) and the component (A) in order to maintain, without aggregation of the component (C), a favorable state of dispersion of the component (C) in the present curable resin composition or in the cured product obtained by curing the curable resin composition, the shell layer may have a structural unit derived from a reactive-group-containing monomer. In other words, the shell layer of the component (C) may contain a reactive group.

For example, the reactive group which the shell layer of the component (C) has, may be at least one type selected from the group consisting of an epoxy group, an oxetane group, a hydroxy group, an amino group, an imide group, a carboxylic acid group, a carboxylic anhydride group, a cyclic ester, a cyclic amide, a benzoxazine group, and a cyanate ester group.

The reactive group which the shell layer of the component (C) has, may be an epoxy group because a resulting cured product has excellent adhesive strength and excellent impact-peel-resistant adhesiveness. In other words, the shell layer of the component (C) may have a structural unit derived from a monomer having an epoxy group, that is, the shell layer may have an epoxy group.

Specific examples of the monomer having an epoxy group encompass glycidyl-group-containing vinyl monomers such as glycidyl (meth)acrylates, 4-hydroxybutyl (meth)acrylate glycidyl ethers, and allyl glycidyl ethers.

In a case where the shell layer of the component (C) has an epoxy group, a content of the epoxy group which the shell layer has with respect to a total mass of the shell layer of the component (C) may be more than 0 mmol/g and not more than 2.0 mmol/g, not less than 0.1 mmol/g and not more than 2.0 mmol/g, or not less than 0.3 mmol/g and not more than 1.5 mmol/g, from the viewpoint of adhesive strength and impact-peel-resistant adhesiveness of a resulting cured product and storage stability of the composition. According to this configuration, aggregation of the component (C) is suppressed, the component (C) can be dispersed in the cured product in the form of primary particles, and, as a result, the cured product can have improved adhesive strength and improved impact-peel-resistant adhesiveness.

The monomer having an epoxy group may be used in the formation of the shell layer, or used only to form the shell layer. In other words, the core layer and the intermediate layer preferably do not have an epoxy group.

In one or more embodiments of the present invention, from the view point of storage stability of the present curable resin composition, it is preferable that the shell layer of the component (C) have no epoxy group.

Specific examples of a monomer having a hydroxy group from which the reactive group contained in the shell layer of the component (C) is derived encompass the above-described hydroxyalkyl (meth)acrylates.

The shell layer may contain a structural unit derived from a polyfunctional monomer having two or more radical polymerizable double bonds, because such a shell layer can prevent swelling of the component (C) in a curable resin composition and also cause viscosity of the curable resin composition to lower and thus lead to improvement in the handleability of the curable resin composition. However, from the viewpoint of the effect of improving the toughness of a resulting cured product and the effect of improving the impact-peel-resistant adhesiveness of the resulting cured product, it is preferable that the shell layer do not contain a structural unit derived from a polyfunctional monomer having two or more radical polymerizable double bonds.

Specific examples of the polyfunctional monomer do not include conjugated diene-based monomers such as butadiene and encompass: allyl alkyl (meth)acrylates such as allyl (meth)acrylate and allyl alkyl (meth)acrylate; allyl oxyalkyl (meth)acrylates; polyfunctional (meth)acrylates that have two or more (meth)acrylic groups such as (poly)ethylene glycol di(meth)acrylate, butanediol di(meth)acrylate, ethylene glycol di(meth)acrylate, triethylene glycol di(meth)acrylate, and tetraethylene glycol di(meth)acrylate; and diallyl phthalate, triallyl cyanurate, triallyl isocyanurate, and divinylbenzene.

Among these polyfunctional monomers, allyl methacrylate and triallyl isocyanurate are preferable.

In one or more embodiments of the present invention, for example, the shell layer of the component (C) may be a polymer consisting only of the following structural unit: (a) 0% by mass to 50% by mass (18 by mass to 50% by mass, or 2% by mass to 48% by mass) of a structural unit derived from an aromatic vinyl-based monomer (for example, styrene); (b) 0% by mass to 50% by mass (0% by mass to 30% by mass, or 10% by mass to 25% by mass) of a structural unit derived from a vinyl cyanide-based monomer (for example, acrylonitrile); (c) 0% by mass to 100% by mass (5% by mass to 100% by mass, or 70% by mass to 95% by mass) of a structural unit derived from a (meth)acrylate-based monomer ((i) may be at least one type of monomer selected from the group consisting of methyl acrylate, butyl acrylate, and methyl methacrylate, (ii) or methyl methacrylate); and (d) 1% by mass to 50% by mass (2% by mass to 35% by mass, or 3% by mass to 20% by mass) of a structural unit derived from a monomer having an epoxy group (particularly, glycidyl methacrylate). Note, however, that in the shell layer of the component (C), (i) a total of the structural unit derived from an aromatic vinyl-based monomer, the structural unit derived from a vinyl cyanide-based monomer, the structural unit derived from a (meth)acrylate-based monomer, and the structural unit derived from a monomer having an epoxy group is 100% by mass, and (ii) the description “a certain structural unit is 0% by mass” is intended to mean that the shell layer of the component (C) may not include a structural unit concerned.

One type of the above-described monomer components may be used alone, or two or more types of the above-described monomer components may be used in combination. The shell layer of the component (C) may contain a structural unit derived from a monomer which differs from the above-described monomers.

The shell layer of the component (C) may have a single-layer structure or a multilayer structure. Further, in a case where the shell layer of the component (C) has a multilayer structure, layers of the multilayer structure may have differing polymer compositions within the above-described range.

### <<Volume-Average Particle Size (Mv) of Component (C)>>

The volume-average particle size (Mv) of the component (C) is not particularly limited, but may be not less than 0.01 μm and not more than 2.00 μm, not less than 0.03 μm and not more than 0.60 μm, not less than 0.05 μm and not more than 0.40 μm, not less than 0.10 μm and not more than 0.30 μm, not less than 0.15 μm and not more than 0.30 μm, not less than 0.16 μm and not more than 0.28 μm, not less than 0.17 μm and not more than 0.27 μm, or not less than 0.18 μm and not more than 0.25 μm, from the viewpoint of industrial productivity and workability of a curable resin composition. In (a) a case where the volume-average particle size (Mv) of the component (C) is not less than 0.01 μm, a curable resin composition has a low viscosity, and thus favorable workability is achieved. In (b) a case where the volume-average particle size (Mv) of the component (C) is not more than 2.00 μm, a polymerization time of the component (C) becomes short, and high industrial productivity is achieved. A method of measuring the volume-average particle size (Mv) of the component (C) will be described in detail in Examples later.

The component (C) may be dispersed in the form of primary particles in the present curable resin composition. In the present specification, the “component (C) is dispersed in the form of primary particles” (hereinafter also referred to as “primary dispersion”) means that a plurality of particles of the component (C) are dispersed so as to be substantially independent from each other (not in contact with each other). This state of dispersion can be confirmed by, for example, dissolving part of the curable resin composition in a solvent such as methyl ethyl ketone, and subjecting a resulting solution to, for example, a particle size measurement apparatus by laser beam scattering to measure the particle size of the components (C) in the curable resin composition.

Further, “stable dispersion” of the component (C) means a state in which the component (C) is, under normal conditions, in a steady state of dispersion over a long period without aggregating, separating, or precipitating in a continuous layer. In addition, it is preferable that: (i) the distribution of the component (C) in a continuous layer remain substantially unchanged; and (ii), even when the composition containing the component (C) is heated within a non-dangerous degree so as to lower the viscosity of the composition and the composition is stirred, “stable dispersion” of the component (C) be maintained.

Note that as the component (C), one type of core shell polymer particles may be used alone, or two or more types of core shell polymer particles may be used in combination.

### <Method for Producing Component (C)>

### (Method for Producing Core Layer)

The core layer included in the component (C) can be formed by polymerizing core monomers by a well-known polymerization method such as an emulsion polymerization method, a suspension polymerization method, or a microsuspension polymerization method. As a specific emulsion polymerization method, a specific suspension polymerization method, or a specific microsuspension polymerization method, for example, the methods described in International Publication No. WO 2005/028546 and International Publication No. WO 2006/070664 can be utilized as appropriate.

### (Method for Forming Shell Layer and Intermediate Layer)

The intermediate layer constituting the component (C) can be formed by polymerizing, by known radical polymerization, a monomer for intermediate layer formation. In a case where a rubber elastic body to be included in the core layer is obtained s an emulsion, it is preferable that the monomer for intermediate layer formation be polymerized by an emulsion polymerization method.

The shell layer constituting the component (C) can be formed by polymerizing, by known radical polymerization, a shell monomer. In a case where the core layer or a polymer particle precursor in which the core layer is covered with the intermediate layer is obtained as an emulsion, it is preferable that the shell monomer be polymerized by an emulsion polymerization method. As the emulsion polymerization method, for example, the method described in International Publication No. WO 2005/028546 can be utilized as appropriate.

In the emulsion polymerization, an emulsifying agent (dispersion agent) is used. Examples of the emulsifying agent encompass (i) anionic emulsifying agents (dispersion agents) such as (i-1) various acids including: alkyl or aryl sulfonic acids typified by dioctylsulfosuccinic acid, dodecylbenzenesulfonic acid, and the like; alkyl or arylether sulfonic acids; alkyl or arylsulfuric acids typified by dodecylsulfuric acids; alkyl or arylether sulfuric acids; alkyl or aryl-substituted phosphoric acids; alkyl or arylether-substituted phosphoric acids; N-alkyl or arylsarcosinic acids typified by dodecylsarcosinic acid; alkyl or arylcarboxylic acids typified by oleic acid, stearic acid, and the like; and alkyl or arylether carboxylic acids and (i-2) alkali metal salts or ammonium salts of these acids, (ii) nonionic emulsifying agents (dispersion agents) such as alkyl or aryl-substituted polyethylene glycols, and (iii) dispersion agents such as polyvinyl alcohols, alkyl-substituted celluloses, polyvinylpyrrolidone, and polyacrylic acid derivatives.

One type of these emulsifying agents (dispersion agents) may be used alone, or two or more types of these emulsifying agents (dispersion agents) may be used in combination.

Using a smaller amount of the emulsifying agent (dispersion agent) is more preferable, as long as there is no negative effect on dispersion stability of an aqueous latex of the polymer particles. A higher water solubility of the emulsifying agent (dispersion agent) is more preferable. A high water solubility facilitates removal of the emulsifying agent (dispersion agent) by washing with water and makes it possible to easily prevent adverse effects on a cured product that is ultimately obtained.

In a case where the emulsion polymerization method is employed, for example, a peroxide (for example, an organic peroxide), a chain transfer agent, and a surfactant can be used as necessary.

As conditions of polymerization such as polymerization temperature, pressure, and deoxygenation, conditions within known ranges can be employed.

A content of the component (C) in the present curable resin composition may be 1 part by mass to 100 parts by mass, 5 parts by mass to 90 parts by mass, 10 parts by mass to 80 parts by mass, 20 parts by mass to 70 parts by mass, or 30 parts by mass to 60 parts by mass, with respect to 100 parts by mass of the component (A), because of an excellent balance achieved between storage stability of a resulting curable resin composition and the effect of improving the toughness of a resulting cured product.

### <Curing Accelerator (D)>

The present curable resin composition may contain a curing accelerator (D). In the present specification, the “curing accelerator (D)” may be referred to as “component (D)”. The component (D) is a compound that functions as a catalyst for accelerating a reaction (i.e., curing reaction) between (i) an epoxy group of the component (A) and (ii) an epoxide reactive group of a component that differs from the component (A) and that is contained in the component (B) and the curable resin composition.

The component (D) is not particularly limited as long as the component (D) has the above-described catalytic activity. Examples of the component (D) encompass: (a) ureas such as 3-(3,4-dichlorophenyl)-1,1-dimethylurea, p-chlorophenyl-N,N-dimethylurea (product name: Monuron), 3-phenyl-1,1-dimethylurea (product name: Fenuron), 3,4-dichlorophenyl-N,N-dimethylurea (product name: Diuron), N-(3-chloro-4-methylphenyl)-N′,N′-dimethylurea (product name: Chlortoluron), and 1,1-dimethylphenylurea (product name: Dyhard); (b) tertiary amines such as benzyldimethylamine, 2,4,6-tris(dimethylaminomethyl) phenol, 2-(dimethylaminomethyl) phenol, 2,4,6-tris(dimethylaminomethyl) phenol incorporated into a poly(p-vinylphenol) matrix, triethylenediamine, and N, N-dimethylpiperidine; (c) imidazoles such as C1-C12 alkyleneimidazole, N-arylimidazole, 2-methylimidazole, 2-ethyl-2-methylimidazole, N-butylimidazole, 1-cyanoethyl-2-undecyl imidazolium trimellitate, and an addition product of epoxy resin and imidazole; and (d) 6-caprolactam. The component (D) may be encapsulated in a microcapsule or the like, or may be a latent catalyst that becomes active only upon a temperature increase. As the component (D), one type of the above compounds may be used alone or two or more types of the above compounds may be used in combination.

The present curable resin composition may contain the component (D) in an amount of 0.1 parts by mass to 10.0 parts by mass, 0.2 parts by mass to 5.0 parts by mass, 0.5 parts by mass to 3.0 parts by mass, or 0.8 parts by mass to 2.0 parts by mass, with respect to 100 parts by mass of the component (A). In a case where the content of the component (D) is (a) not less than 0.1 parts by mass with respect to 100 parts by mass of the epoxy resin (A), favorable curability of the preset curable resin composition can be attained. On the other hand, in a case where the content is (b) not more than 10.0 parts by mass with respect to 100 parts by mass of the epoxy resin (A), the present curable resin composition advantageously have favorable storage stability and is advantageously easy to handle.

### <Inorganic Filler>

The present curable resin composition may contain an inorganic filler. The present curable resin composition, by containing an inorganic filler, brings about the effect of allowing a resulting cured product to have more excellent rigidity at a high temperature.

Examples of the inorganic filler encompass: silicic acids and/or silicates such as dry silica, wet silica, aluminum silicate, magnesium silicate, and calcium silicate; reinforcing fillers such as wollastonite, talc, dolomite, and carbon black; and fillers such as calcium oxide, ground calcium carbonate, colloidal calcium carbonate, magnesium carbonate, titanium oxide, ferric oxide, aluminum fine powder, zinc oxide, and active zinc oxide. One type of the above-described inorganic fillers may be used alone, or two or more types of the above-described inorganic fillers may be used in combination.

The dry silica is also referred to as fumed silica. Examples of the fumed silica encompass non-surface-treated hydrophilic fumed silica and hydrophobic fumed silica which is produced by chemically treating a silanol group part of hydrophilic fumed silica with silane or siloxane. The fumed silica may be hydrophobic fumed silica from the viewpoint of dispersibility in the component (A).

A content of the inorganic filler in the present curable resin composition may be 1 part by mass to 300 parts by mass, 5 parts by mass to 200 parts by mass, or 10 parts by mass to 150 parts by mass, with respect to 100 parts by mass of the component (A). In a case where the content of the inorganic filler is within the above-described range, there is an advantage in that a resulting cured product has even better rigidity at a high temperature and has even better adhesive strength.

### <Another Component(s)>

The present curable resin composition may contain, as necessary, another component (other components) other than the above-described components. Examples of the other component(s) encompass: a curing agent other than dicyandiamide; a phenol compound; a blocked urethane; a reinforcing agent; a calcium oxide; a radically curable a resin; a monoepoxide; photopolymerization initiator; an expanding agent such as an azo type chemical foaming agent and thermally expandable microballoons; fiber pulp such as aramid-based pulp; a colorant such as a pigment and a dye; an extender; an ultraviolet ray absorbing agent; an antioxidant; a stabilizer (antigelling agent); a plasticizing agent; a leveling agent; a defoaming agent; a silane coupling agent; an antistatic agent; a flame retarder; a lubricant; a viscosity reducer; a shrinkage reducing agent; an organic filler; a thermoplastic resin; a desiccant; and a dispersion agent.

### <Method for Producing Curable Resin Composition>

A method for producing the present curable resin composition is not particularly limited, and various methods can be utilized. Examples of the methods encompass: a method in which the component (C) obtained in the state of aqueous latex is brought into contact with the component (A), and then, from a resulting mixture, an unnecessary component(s) such as water is removed; and a method in which, after the component (C) is extracted into an organic solvent, the component (C) is mixed with the component (A), and then the organic solvent is removed from the resulting mixture. As such a production method, specifically, the method described in International Publication No. WO 2005/028546 may be utilized. More specifically, the present curable resin composition may be prepared by a production method including the following first to third steps:
a first step of mixing an aqueous latex containing the component (C) (specifically, a reaction mixture obtained by producing the component (C) by emulsion polymerization) into an organic solvent whose water solubility at 20° C. is 5% by mass to 40% by mass, and then further mixing a resultant mixture with an excess amount of water so as to aggregate the component (C);
a second step of separating and collecting, from a liquid phase, the component (C) aggregated, and then once again mixing the component (C) into the organic solvent so as to obtain an organic solvent solution of the polymer particles (C); and
a third step of further mixing the organic solvent solution of the component (C) with the component (A) and then distilling off the organic solvent.

The present curable resin composition can be obtained by mixing, with a dispersion in which the component (C) is dispersed in the form of primary particles in the component (A) and which is obtained through the above first to third steps, an additional component (A) and a component (B) and, if necessary, a component (D), an inorganic filler, and the other component(s). Further, according to such a production method, it is possible to obtain the present curable resin composition in a state in which the component (C) is dispersed in the form of primary particles. In a case where the present curable resin composition is a composition in which the component (C) is dispersed in the form of primary particles in the component (A), there is an advantage in that a resulting cured product has excellent impact-peel-resistant adhesive strength.

In addition, it is possible to produce the present curable resin composition by redispersing, in the component (A) with use of a dispersion apparatus which has a high mechanical shear force, the component (C) in a powder form which has been obtained by drying following coagulation with use of a method such as salting-out. Examples of the dispersion apparatus encompass a three-roll paint mill, a roll mill, and a kneader. In this case, it is possible to efficiently disperse the component (C) in the component (A) by applying mechanical shear force to the component (A) and the component (C) at a high temperature. In a case where the present curable resin composition is produced by applying mechanical shear force with use of a dispersion apparatus, the temperature at which the component (C) is dispersed in the component (A) (temperature in applying the mechanical shear force) may be 50° C. to 200° C., 70° C. to 170° C., 80° C. to 150° C., or 90° C. to 120° C.

The curable resin composition according to one or more embodiments of the present invention can be used as a one-component curable resin composition. The one-component curable resin composition is applied and then cured by heat and/or light, after all components have been mixed therein and stored in a sealed state. Alternatively, the curable resin composition can be prepared in advance as a two-liquid-type or multiple-liquid-type curable resin composition, which includes: a liquid A that contains the component (A) as a main component and that also contains the component (C); and a liquid C that is prepared separately from the liquid A and that contains the component (B) and, if necessary, contains the component (D), and, if necessary, further contains the component (C). Then, the liquid A and the liquid C can be mixed immediately before use and used. Note that the curable resin composition according to one or more embodiments of the present invention is particularly useful in a case where the curable resin composition is used as a one-component curable resin composition.

In a case where the present curable resin composition is a two-liquid-type or multiple-liquid-type curable resin composition, the component (C) only needs to be contained at least in the liquid A or the liquid C. That is, the component (C) may be contained only in the liquid A, or may be contained only in the liquid C. Alternatively, the component (C) may be contained in both of the liquid A and the liquid C.

### (2-2. Adherend)

The following description will discuss in detail an adherend in accordance with one or more embodiments of the present invention (hereinafter may be referred to as “the present adherend”). The term “adherend” may be referred to as “substrate” or “adhesive substrate”.

Examples of a material of the present adherend include wood, metals, plastic, and glass. Specific examples of the substrates encompass (i) steel materials such as cold-rolled steel and hot-dip galvanized steel, (ii) aluminum materials such as aluminum and coated aluminum, and (iii) various plastic based substrates such as general purpose plastic, engineering plastic, and composite materials such as CFRP and GFRP.

In the present production method, at least two adherends, that is, a first adherend and a second adherend, are used as adherends. The first adherend and the second adherend in the present production method may be made of the same type of material or different types of materials. With regard to the first adherend and the second adherend, at least one of these adherends or both of these adherends may be made of a steel material in view of advantages of being inexpensive, having high strength, and having excellent weldability and shapeability. In other words, in one or more embodiments of the present invention, the first adherend and/or the second adherend may be made of a steel material(s), or both of the first adherend and the second adherend may be made of a steel material(s).

Respective thicknesses of the first adherend and the second adherend in the present production method are not particularly limited. The thicknesses may be 0.4 mm to 3.2 mm, 0.8 mm to 2.4 mm, or 1.2 mm to 1.6 mm. The first adherend and the second adherend in the present production method may have the same thickness, or may have differing thicknesses.

The average thickness (X) of the first adherend and the second adherend (hereinafter may be simply referred to as “(X)”) is not particularly limited. The average thickness (X) may be 0.4 mm to 3.2 mm, 0.8 mm to 2.4 mm, or 1.2 mm to 1.6 mm. Note that the average thickness (X) of the first adherend and the second adherend can be calculated on the basis of the following expression: Average thickness (X) of first adherend and second adherend=(thickness of first adherend+thickness of second adherend)/2.

### (2-3. Step (i) (Bonding Step))

In the present production method, step (i) is the step of bonding the second adherend to the first adherend after applying the present curable resin composition to the first adherend. In this case, the first adherend and the second adherend are bonded to each other such that the present curable resin composition applied to the first adherend is sandwiched between the first adherend and the second adherend. Further, in this case, the curable resin composition that is sandwiched between the first adherend and the second adherend may partially protrude from the first adherend and/or the second adherend. The present curable resin composition may be applied to the second adherend, as necessary, in addition to the first adherend. It can also be said that the step (i) in accordance with one or more embodiments of the present invention (hereinafter may be referred to as “the present step (i)”) is the step of obtaining a structure (hereinafter may be referred to as “structure (i)”) in which the first adherend, the present curable resin composition, and the second adherend are layered in this order.

In the present step (i), a method of applying the present curable resin composition to the first adherend (and, as necessary, to the second adherend) is not particularly limited, and it is possible to apply the present curable resin composition by any method. For example, the present curable resin composition can be applied to the first adherend by: a method in which the present curable resin composition is applied by extruding, on the first adherend, the present curable resin composition in a bead-like, monofilament-like, or swirl form with use of an application robot; a mechanical application method, for example, with use of a caulking gun; a jet spray method or a streaming method; or a method using another manual application means.

In the present step (i), it is preferable to adjust the thickness of the present curable resin composition in a resulting structure (i) such that a ratio (Y/X) between the thickness (Y) of the cured product obtained by curing the curable resin composition (hereinafter may be simply referred to as “(Y)”) and the average thickness (X) of the first adherend and the second adherend is 0.5 to 10.0. The thickness of the curable resin composition in which a value of (Y/X) is 0.5 to 10.0 in a resulting cured product cannot be generally specified because the thickness varies with the average thickness of the first adherend and the second adherend which are used. However, the thickness may be, for example, 0.2 mm to 4 mm, 0.3 mm to 3 mm, or 0.4 mm to 2 mm. In other words, in the present step (i), it is preferable to adjust, in the above range, the thickness of the curable resin composition to be applied.

A method of adjusting the thickness of the present curable resin composition in the resulting structure (i) is not particularly limited. Examples of the method encompass: (1) a method in which the curable resin composition that has been applied to the first adherend is spread out with use of, for example, a spatula; or (2) a method in which, in bonding the second adherend to the first adherend, the curable resin composition is compressed by the adherends and spread out in a state in which the present curable resin composition is sandwiched between those two adherends.

In the present step (i), as described above, it is preferable to adjust the thickness of the present curable resin composition in the resulting structure (i) such that the thickness of a cured product obtained by curing the curable resin composition becomes a desired thickness (thickness adjustment step).

### (2-4. Step (ii) (Curing Step))

In the present production method, step (ii) is the step of curing the present curable resin composition which is present between the first adherend and the second adherend in the structure (i) obtained in the step (i). In the step (ii), by curing the present curable resin composition, it is possible to obtain a laminate in which those two adherends (the first adherend and the second adherend) are bonded together by a cured product that is obtained by curing the present curable resin composition (hereinafter may be referred to as “laminate”).

In the step (ii) in accordance with one or more embodiments of the present invention (hereinafter may be referred to as “the present step (ii)”), the present curable resin composition in the structure (i) is cured by heating the curable resin composition. Therefore, it can also be said that the present step (ii) is a “heating step” or a “heat-curing step”.

A curing temperature (temperature for heating the present curable resin composition) in the present step (ii) may be 105° C. to 145° C., 115° C. to 140° C., or 125° C. to 135° C. Note that the “curing temperature” is the atmospheric temperature in a space where the present curable resin composition is heated, and in a case where the step (ii) is carried out with the use of a baking furnace, the “curing temperature” is a set temperature of the baking furnace. In the step (ii), a curing temperature of not more than 145° C. can reduce, for example, an amount of fuel required for heating, and thus can contribute to achieving carbon neutrality.

A curing time (time to heat the present curable resin composition) in the present step (ii) may be 10 minutes to 60 minutes, 15 minutes to 40 minutes, or 15 minutes to 30 minutes. Note that the “curing time” is a time for which the present curable resin composition is kept in the space where the present curable resin composition is heated. In a case where the step (ii) is carried out with use of a baking furnace, the “curing time” is a time from when the structure (i) is put in the baking furnace until when the structure (i) is taken out. In the present step (ii), a curing time of not more than 60 minutes can reduce, for example, an amount of fuel required for heating, and thus can contribute to achieving carbon neutrality.

In the present specification, “low-temperature curing” refers to heat-curing of a curable resin composition containing an epoxy resin which is carried out under the above-described conditions of a curing temperature of not more than 145° C. (105° C. to 145° C.) and a curing time of not more than 60 minutes. It can also be said that the present step (ii) is a low-temperature curing step.

In a case where the present curable resin composition is used as an adhesive for automobiles, in other words, in a case where the present production method is used in production of a vehicle body structure, it is preferable, from the viewpoint of shortening and simplifying steps, that, after the present curable resin composition is applied to an automobile member which is an adherend, coating such as electrodeposition coating be further applied and then, the present curable resin composition be cured simultaneously with baking and curing of the coating.

### (2-5. Laminate and Cured Product)

The following description will discuss in detail a laminate in accordance with one or more embodiments of the present invention and a cured product (a cured product obtained by curing the present curable resin composition) in the laminate. In the present specification, a “laminate in accordance with one or more embodiments of the present invention” may be referred to as “the present laminate”, and a “cured product in accordance with one or more embodiments of the present invention” may be referred to as “the present cured product”.

<Ratio between Thickness of Cured Product and Thickness of Adherend>

The ratio (Y/X) between the thickness (Y) of the present cured product and the average thickness (X) of the first adherend and the second adherend in the present laminate is 0.5 to 10.0. In a case where the (Y/X) is controlled to be 0.5 to 10.0, in other words, the above steps (i) and (ii) are controlled such that the (Y/X) becomes 0.5 to 10.0, it is possible to provide, even in a case where low-temperature curing is carried out, a laminate in which an adherend is bonded by a cured product having a high elastic modulus in a high-temperature environment. The (Y/X) in the present laminate may be more than 0.5 and not more than 5.0, or 0.7 to 3.0.

### <Glass Transition Temperature of Cured Product>

A glass transition temperature (Tg1) in degrees Celsius of the present cured product is not particularly limited. The glass transition temperature (Tg1) may be not lower than 120° C., not lower than 122° C., or not lower than 125° C. since such a glass transition temperature can reduce a decrease in elastic modulus of the cured product in a high-temperature environment. Note that a method of measuring the glass transition temperature (Tg1) of the cured product is as described in Examples. Note that it can also be said that Tg1 is a glass transition temperature in degrees Celsius of a cured product obtained by low-temperature curing of the present curable resin composition. It can also be said that Tg1 is a glass transition temperature in degrees Celsius of a cured product in the laminate immediately after the step (ii) (immediately after production of a laminate).

A glass transition temperature (Tg2) in degrees Celsius of a cured product obtained by heat-curing the present curable resin composition under sufficient heating conditions (in the present specification, conditions of a curing temperature of 130° C. and a curing time of 2 hours) is not particularly limited. However, the glass transition temperature (Tg2) may be not less than 20° C., not less than 50° C., not less than 80° C., not less than 100° C., not less than 120° C., or not less than 130° C. Note that a method of measuring the glass transition temperature (Tg2) of the cured product is as described in Examples. Note that it can also be said that Tg2 is a glass transition temperature in degrees Celsius of a cured product obtained by heat-curing the present curable resin composition under sufficient heating conditions (in the present specification, conditions of a curing temperature of 130° C. and a curing time of 2 hours).

### <Achievement Ratio of Glass Transition Temperature>

An achievement ratio of glass transition temperature of a cured product is a ratio (Tg1/Tg2) between (1) a glass transition temperature (Tg1) in degrees Celsius of the cured product which is obtained by low-temperature curing of the curable resin composition containing an epoxy resin and (2) a glass transition temperature (Tg2) in degrees Celsius of the cured product which is obtained by heat-curing under sufficient heating conditions (in the present specification, conditions of a curing temperature of 130° C. and a curing time of 2 hours). Note that the achievement ratio of glass transition temperature of the cured product can be calculated according to the following expression:

$$Achievement ratio ( \% ) of glass transition temperature of cured product = ( glass transition temperature ( Tg 1 ) ( ° C . ) in degrees Celsius of cured product obtained by curing curable resin composition at curing temperature of 130 ° C . for curing time of 20 minutes / glass transition temperature ( Tg 2 ) ( ° C . ) in degrees Celsius of cured product obtained by curing curable resin composition at curing temperature of 130 ° C . for curing time of 120 minutes ) \times 100.$$

A cured product obtained by curing a curable resin composition containing an epoxy resin has a crosslink density (conversion rate of curing) that varies depending on the curing temperature and the curing time. As a result, the glass transition temperature of the cured product obtained by curing the curable resin composition containing an epoxy resin also changes depending on the curing temperature and the curing time. The inventors of one or more embodiments of the present invention have found that, particularly, in a case where low-temperature curing of the curable resin composition is carried out, the glass transition temperature of a resultant cured product is likely to be significantly lower than that in a case where heat-curing is carried out under sufficient heating conditions (for example, conditions of a curing temperature of 130° C. and a curing time of 2 hours). Note that, in a case where the curable resin composition is cured for a sufficiently long time, a curing reaction is completed (the conversion ratio of curing becomes 100% or substantially 100%). As a result, the curable composition reaches a glass transition temperature that is unique to a cured product made from each composition. In the present specification, the sufficient heating conditions are intended to mean heating conditions under which a curing reaction is completed. Further, it can also be said that the glass transition temperature (Tg2) of a cured product obtained by heat curing under the sufficient heating conditions is the glass transition temperature of the cured product at the time when the curing reaction is completed.

The inventors H one or more embodiments of the present invention considered that a decrease in glass transition temperature in low-temperature curing was one of causes of a significant decrease in elastic modulus of a resulting cured product in a high-temperature environment in a case where the curable resin composition had been subjected to the low-temperature curing. Conversely, the inventors of one or more embodiments of the present invention considered that it would be possible to provide a cured product which had a high elastic modulus in a high-temperature environment if it was possible to inhibit a decrease in glass transition temperature during low-temperature curing.

The achievement ratio of glass transition temperature (Tg1/Tg2) is an index that indicates a degree of inhibition of a decrease in glass transition temperature during low-temperature curing. A higher Tg1/Tg2 means that a decrease in glass transition temperature is inhibited during low-temperature curing. In other words, a higher Tg1/Tg2 means that a decrease in elastic modulus of a cured product is inhibited in a high-temperature environment. Accordingly, from the viewpoint of providing a cured product which has a high elastic modulus even in a high-temperature environment, the achievement ratio (Tg1/Tg2) of glass transition temperature of the cured product in a laminate that is obtained by the present production method may be not less than 80%, not less than 818, or not less than 83%. The achievement ratio (Tg1/Tg2) of glass transition temperature of the cured product in the laminate can be measured by a method described in Examples.

Note that the achievement ratio of glass transition temperature can be controlled by adjusting: composition of the curable resin composition (particularly, composition of the epoxy resin); and the ratio between the thickness of the cured product and the thickness of the adherends.

### <Storage Modulus (E′) at 120° C. >

The present cured product has a high elastic modulus in a high-temperature environment. In the present specification, an “elastic modulus at a high temperature” of the cured product can be evaluated by the storage modulus E′ of the cured product at 120° C. The storage modulus of the cured product at 120° C. can be measured by a tensile mode of dynamic viscoelasticity measurement, and can be measured at a frequency of, for example, at 1 Hz.

The storage modulus of the present cured product at 120° C. may be not less than 0.07 GPa, not less than 0.08 GPa, not less than 0.09 GPa, or not less than 0.10 GPa. A higher storage modulus of the cured product at 120° C. means that the cured product has a better elastic modulus in a high-temperature environment. The upper limit of the storage modulus of the present cured product at 120° C. is not particularly limited, but can be, for example, not more than 5.0 GPa.

### <Storage Modulus (E′) at 100° C.>

In the present specification, the “elastic modulus at a high temperature” of the cured product can be evaluated by the storage modulus E′ of the cured product at 100° C. The storage modulus of the cured product at 100° C. can be measured by the tensile mode of dynamic viscoelasticity measurement, and can be measured at a frequency of, for example, at 1 Hz.

The storage modulus of the present cured product at 100° C. may be not less than 1.05 GPa, not less than 1.1 GPa, not less than 1.2 GPa, or not less than 1.3 GPa. A higher storage modulus of the cured product at 100° C. means that the cured product has a better elastic modulus in a high-temperature environment. The upper limit of the storage modulus of the present cured product at 100° C. is not particularly limited, but can be, for example, not more than 5.0 GPa.

### <Storage Modulus (E′) at 23° C.>

The cured product is also excellent in elastic modulus at room temperature. In the present specification, the “elastic modulus at room temperature” of the cured product can be evaluated by the storage modulus E′ of the cured product at 23° C. The storage modulus of the cured product at 23° C. can be measured by the tensile mode of dynamic viscoelasticity measurement, and can be measured at a frequency of, for example, at 1 Hz.

The storage modulus of the present cured product at 23° C. may be not less than 1.0 GPa, not less than 1.5 GPa, or not less than 2.0 GPa. A higher storage modulus of the cured product at 23° C. means that the cured product has a better elastic modulus at room temperature. The upper limit of the storage modulus of the present cured product at 23° C. is not particularly limited, but can be, for example, not more than 5.0 GPa.

In a case where, regarding a cured product that is obtained by low-temperature curing of the curable resin composition, the storage modulus of the cured product at 23° C. is not less than 1.0 GPa and the glass transition temperature (Tg1) in degrees Celsius of the cured product is not less than 120° C., the storage modulus and the glass transition temperature mean the following: the cured product is a laminate obtained by bonding an adherend with use of a cured product which has a high elastic modulus in a high-temperature environment even in a case where this cured product has been cured at a low temperature in a short time. Accordingly, it is preferable that the cured product in the laminate that is obtained by the present production method have a storage modulus of not less than 1.0 GPa at 23° C. and a glass transition temperature (Tg1) in degrees Celsius of not less than 120° C.

### <Application of Laminate>

For example, the present laminate can be suitably applied to bonding of members in production of, for example, vehicle bodies of automobiles and vehicles (e.g., Shinkansens (bullet trains), and trains), aircrafts, spaceships, aerospace stations, buildings, constructions, and wind power plants, and particularly to bonding of members in production of vehicle body structures (more specifically, floor panels, center pillars, and the like). In other words, one or more embodiments of the present invention provides a method for producing a vehicle body structure, the method including the present production method as one step.

### 3. Others

One or more embodiments of the present invention may include the following.
<1> A method for producing a laminate in which a first adherend, a cured product obtained by curing a curable resin composition, and a second adherend are layered in this order, the method including the steps of: (i) applying the curable resin composition to the first adherend and bonding the second adherend with the first adherend (bonding step); and (ii) curing the curable resin composition (curing step), the curable resin composition containing an epoxy resin (A), and dicyandiamide (B) in an amount of 3.5 parts by mass to 19.0 parts by mass with respect to 100 parts by mass of the epoxy resin (A), the epoxy resin (A) containing an unmodified bisphenol A epoxy resin (A-1) in an amount of 51% by mass to 100% by mass in 100% by mass of a total amount of the epoxy resin (A), in step (ii), the curable resin composition being cured at a curing temperature of 105° C. to 145° C., in step (ii), the curable resin composition being cured for a curing time of 10 minutes to 60 minutes, and a thickness (Y) of the cured product and an average thickness (X) of the first adherend and the second adherend being at a ratio (Y/X) of 0.5 to 10.0.
<2> The method according wherein an achievement ratio of glass transition temperature of the cured product is not less than 80%, the achievement ratio of glass transition temperature of the cured product being a value calculated according to the following expression: Achievement ratio of glass transition temperature of the cured product=(glass transition temperature (Tg1) (° C.) in degrees Celsius of a cured product obtained by curing the curable resin composition at a curing temperature of 130° C. for a curing time of 20 minutes/glass transition temperature (Tg2) (C) in degrees Celsius of a cured product obtained by curing the curable resin composition at a curing temperature of 130° C. for a curing time of 120 minutes)×100.
<3> The method according to <1> or <2>, wherein the cured product has a storage modulus of not less than 1 GPa at 23° C., the storage modulus being obtained by measurement under a condition of a frequency of 1 Hz in a tensile mode of dynamic viscoelasticity measurement.
<4> The method according to any one of <1> to <3>, wherein the cured product has a storage modulus of not less than 0.07 GPa at 120° C., the storage modulus being obtained by measurement under a condition of a frequency of 1 Hz in a tensile mode of dynamic viscoelasticity measurement.
<5> The method according to any one of <2> to <4>, wherein the glass transition temperature (Tg1) of the cured product is not lower than 120° C.
<6> The method according to any one of <1> to <5>, wherein the epoxy resin (A) does not contain an aliphatic polybasic acid-modified epoxy resin (A-3).
<7> The method according to any one of <1> to <5>, wherein: the epoxy resin (A) contains an aliphatic polybasic acid-modified epoxy resin (A-3), the aliphatic polybasic acid-modified epoxy resin (A-3) being contained in an amount of more than 0% by mass and less than 3% by mass in the epoxy resin.
<8> The method according to any one of <1> to <7>, wherein the first adherend or the second adherend or a combination of the first adherend and the second adherend is a steel sheet.
<9> The method according to any one of <1> to <8>, wherein the curable resin composition further contains polymer particles (C) in an amount of 1 part by mass to 100 parts by mass with respect to 100 parts by mass of the epoxy resin (A), the polymer particles (C) having a core-shell structure that includes a core layer and a shell layer.
<10> The method according to any one of <1> to <9>, wherein the curable resin composition further contains a curing accelerator (D) in an amount of 0.1 parts by mass to 15 parts by mass with respect to 100 parts by mass of the epoxy resin (A).
<11> The method according to <9>, wherein the core layer contains at least one type selected from the group consisting of diene-based rubbers, (meth)acrylate-based rubbers, and organosiloxane-based rubbers.
<12> The method according to <9> or <11>, wherein the core layer is made of butadiene rubber or butadiene-styrene rubber or a combination of butadiene rubber and butadiene-styrene rubber.
<13> The method according to any one of <10> to <12>, wherein the shell layer contains a structural unit derived from at least one type of monomer selected from the group consisting of aromatic vinyl-based monomers, vinyl cyanide-based monomers, and (meth)acrylate-based monomers.
<14> A method for producing a vehicle body structure, including: the method for producing a laminate according to any one of <1> to <13>.

### EXAMPLES

The following description will discuss one or more embodiments of the present invention in more detail with reference to Examples. Note, however, that one or more embodiments of the present invention are not limited to these examples.

### Materials

Substances used in the Examples and Comparative Examples are indicated below.

### (Component (A))

Component (A-1): JER828 (manufactured by Mitsubishi Chemical Corporation; bisphenol A epoxy resin which is liquid at normal temperature; epoxy equivalent weight: 184 to 194)
Component (A-2): JER807 (manufactured by Mitsubishi Chemical Corporation; bisphenol F epoxy resin which is liquid at normal temperature; epoxy equivalent weight: 160 to 175)
Component (A-3): JER871 (manufactured by Mitsubishi Chemical Corporation; dimer acid-modified epoxy resin; epoxy equivalent weight: 410 g/eq)

### (Another Epoxy Resin)

HyPox RA840 (manufactured by CVC; rubber-modified epoxy resin; epoxy equivalent weight: 350)

### (Component (B))

Dyhard 100S (manufactured by AlzChem; dicyandiamide)

### (Component (C))

As the component (C), polymer particles prepared by a method described below were used. Note that, as described later, the component (C) was used in the form of a dispersion (M-1) in which the polymer particles prepared were dispersed in the component (A) (component (A-1)).

### 1. Formation of Core Layer

### Production Example 1-1: Preparation of Polybutadiene Rubber Latex (R-1)

Into a 100 L pressure-resistant polymerization apparatus were introduced 200 parts by mass of deionized water, 0.03 parts by mass of tripotassium phosphate, 0.25 parts by mass of potassium dihydrogenphosphate, 0.002 parts by mass of disodium ethylenediaminetetraacetate (EDTA), 0.001 parts by mass of ferrous sulfate heptahydrate (FE), and 1.5 parts by mass of sodium dodecylbenzenesulfonate (SDS) as an emulsifying agent. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 100 parts by mass of butadiene (BD) was introduced into the pressure-resistant polymerization apparatus, and the temperature inside the pressure-resistant polymerization apparatus was raised to 45° C. Thereafter, 0.015 parts by mass of paramenthane hydroperoxide (PHP) was introduced into the pressure-resistant polymerization apparatus, and subsequently 0.04 parts by mass of sodium formaldehyde sulfoxylate (SFS) was introduced into the pressure-resistant polymerization apparatus, and polymerization commenced. At the time 10 hours had elapsed from the start of polymerization, devolatilization was carried out under reduced pressure to remove the remaining monomer that was not used in polymerization, so as to end the polymerization. During the polymerization, PHP, EDTA, and FE were each added to the pressure-resistant polymerization apparatus in discretionarily selected amounts and discretionarily selected points in time. Through this polymerization operation was obtained a latex (R-1), which included a core layer (polybutadiene rubber particles) whose main component was polybutadiene rubber. The volume-average particle size of the polybutadiene rubber particles contained in the latex thus obtained was 0.10 μm.

### Production Example 1-2: Preparation of Polybutadiene Rubber Latex (R-2)

Into a 100 L pressure-resistant polymerization apparatus were introduced 7 parts by mass of solid content of the polybutadiene rubber latex (R-1) obtained in Production Example 1-1, 200 parts by mass of deionized water, 0.03 parts by mass of tripotassium phosphate, 0.002 parts by mass of EDTA, and 0.001 parts by mass of FE. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 93 parts by mass of BD was introduced into the pressure-resistant polymerization apparatus, and the temperature inside the pressure-resistant polymerization apparatus was raised to 45° C. Thereafter, 0.02 parts by mass of PHP was introduced into the pressure-resistant polymerization apparatus, and subsequently 0.10 parts by mass of SFS was introduced into the pressure-resistant polymerization apparatus, and polymerization was commenced. At the time 30 hours had elapsed from the start of polymerization, devolatilization was carried out under reduced pressure to remove the remaining monomer that was not used in polymerization, so as to end the polymerization. During the polymerization, PHP, EDTA, and FE were each added to the pressure-resistant polymerization apparatus in discretionarily selected amounts and discretionarily selected points in time. Through this polymerization operation was obtained a latex (R-2), which included a core layer (polybutadiene rubber particles) whose main component was polybutadiene rubber. The volume-average particle size of the polybutadiene rubber particles contained in the latex thus obtained was 0.20 μm.

### 2. Preparation of Polymer Particles Having Core-Shell Structure (Formation of Shell Layer)

### Production Example 2-1: Preparation of Core Shell Polymer Latex (L-1)

Into a glass reaction vessel were introduced 262 parts by mass of the polybutadiene rubber latex (R-2) prepared in Production Example 1-2 (including 87 parts by mass of polybutadiene rubber particles) and 57 parts by mass of deionized water. The glass reaction vessel had a thermometer, a stirrer, a reflux condenser, a nitrogen inlet, and a monomer adding device. The gas in the glass reaction vessel was replaced with nitrogen, and while doing so the materials in the glass reaction vessel were stirred at 60° C. Next, 0.004 parts by mass of EDTA, 0.001 parts by mass of FE, and 0.2 parts by mass of SFS were added into the glass reaction vessel. Thereafter, a mixture of (i) a monomer for shell layer formation (1 part by mass of methyl methacrylate (MMA), 6 parts by mass of styrene (ST), 2 parts by mass of acrylonitrile (AN), and 4 parts by mass of glycidyl methacrylate (GMA)) and (ii) 0.04 parts by mass of cumene hydroperoxide (CHP) was added continuously into the glass reaction vessel over 120 minutes. Thereafter, 0.04 parts by mass of CHP was added into the glass reaction vessel, and the resulting mixture in the glass reaction vessel was stirred for 2 hours so as to finish polymerization. Through the above operations was obtained an aqueous latex (L-1) which contained polymer particles (component (C)) having a core-shell structure. The polymerization conversion ratio of the monomer component was not less than 99%. Resultant polymer particles had a volume-average particle size of 0.21 μm, and a content of the epoxy group with respect to a total amount of the shell layer was 2.2 mmol/g.

### 3. Preparation of Dispersion (M) in which Component (C) was Dispersed in Component (A)

### Production Example 3-1: Preparation of Dispersion (M-1)

Into a 1 L mixing vessel at 25° C. was introduced 132 g of methyl ethyl ketone (MEK). Next, while the MEK was stirred, 132 g of the aqueous latex (L-1) (containing 40 g of the component (C)) which contained the polymer particles obtained in the above Production Example 2-1 was introduced into the mixing vessel. After the materials in the mixing vessel had been mixed uniformly, 200 g of water was introduced into the mixing vessel at a feed rate of 80 g/min while the materials in the mixing vessel were stirred. After the water had been fed, the stirring was promptly stopped, and a slurry liquid was obtained, the slurry liquid being constituted by (i) an aggregate that contained the component (C) and (ii) an aqueous phase that contained a small amount of organic solvent. The aggregate was buoyant. Next, 360 g of the aqueous phase was let out from an outlet in a lower part of the mixing vessel such that the aggregate containing a portion of the aqueous phase remained in the mixing vessel. To the aggregate thus obtained was added 90 g of MEK, and these were mixed uniformly so as to obtain a dispersion liquid in which the core shell polymer was dispersed uniformly in the MEK. To this dispersion liquid was added 60 g of the component (A-1) and these were mixed uniformly. The MEK was removed from the resulting mixture with use of a rotary evaporator. Through the above operations, a dispersion (M-1) in which the component (C) was dispersed in the component (A-1).

### (Curing Accelerator (D))

Dyhard UR200 (manufactured by AlzChem; 3-(3,4-dichlorophenyl)-1,1-dimethylurea

### (Inorganic Filler)

Fumed silica: CAB-O-SIL TS-720 (manufactured by CABOT; fumed silica surface-treated with polydimethylsiloxane)
Calcium carbonate: Whiton SB (manufactured by Shiraishi Calcium; non-treated ground calcium carbonate)
Calcium oxide: CML #31 (manufactured by Ohmi Chemical Industry; calcium oxide that has been surface-treated with fatty acid)

### [Measurement Method]

The following describes measurement methods for respective physical properties that are measured in Examples.

### (Volume-Average Particle Size of Polymer Particles)

The volume-average particle size (Mv) of the polymer particles which were dispersed in the core shell polymer latex described in the Production Examples was measured with use of Microtrac UPA150 (manufactured by Nikkiso Co., Ltd.). In measurement, samples used for measurement were each prepared by diluting the core shell polymer latex in deionized water. Note that in the measurement, the refractive index of water and the refractive index of polymer particles of each of the samples were inputted, measurement time was set to 600 seconds, and the concentration of the sample was adjusted such that the signal level fell within a range of 0.6 to 0.8.

### (Measurement of Glass Transition Temperature and Storage Modulus)

A method for measuring the glass transition temperature and the storage modulus of a cured product obtained by curing the curable resin composition was as follows: a curable resin composition was applied between two fluorine-coated steel sheets that measure 25 mm in width and 100 mm in length; these two steel sheets were superimposed on top of each other such that the curable resin composition had a thickness of 0.2 to 1.3 mm; and then, curing (low-temperature curing) was carried out under conditions of a curing temperature of 130° C. and a curing time of 20 minutes, so that a laminate in which the two steel sheets were bonded together by the cured product was obtained. A plate-like cured product was peeled off from the laminate that had been obtained, and the thickness of the plate-like cured product was measured with use of a vernier caliper. Here, with regard to thicknesses of the steel sheets used, the steel sheets used had thicknesses which were similar to those of the steel sheets used in a corresponding Example or Comparative Example (i.e., a thickness of 1.6 mm, 0.8 mm, or 0.5 mm). The cured product was cut into a strip that measured 30 mm in length and 5 mm in width. With use of a dynamic viscoelasticity measurement apparatus (DMA), storage moduli E′ at 23° C., 100° C., and 120° C. were measured at a frequency of 1 Hz in a tensile mode. Also, a glass transition temperature (Tg1) in degrees Celsius was measured as a temperature at which loss tangent (tan 8) reached its maximum.

### (Achievement Ratio of Glass Transition Temperature)

Except that the curing conditions of the curable resin composition were changed to conditions of a curing temperature of 130° C. and a curing time of 2 hours, the above-described operations were used to measure, for each curable resin composition, the glass transition temperature (Tg2) in degrees Celsius of the cured product at the time when a curing reaction was completed. The achievement ratio of glass transition temperature was calculated on the basis of the following expression:

$$Achievement ratio of glass transition temperature = ( Tg 1 ( ° C . ) / Tg 2 ( ° C . ) ) \times 100.$$

### Examples 1 to 7 and Comparative Examples 1 to 4

Components were each measured so as to conform to a formulation indicated in Table 1, and sufficiently mixed, so that a curable resin composition was obtained. The curable resin composition was applied to a fluorine-coated steel sheet (first adherend) having the thickness described in Table 1. Further, another fluorine-coated steel sheet (second adherend) having the thickness described in Table 1 was bonded with the first adherend (bonding step). A resulting structure was heat-cured (low-temperature curing) under the conditions of a curing temperature of 130° C. and a curing time of 20 minutes (curing step), so that a laminate was obtained. The laminate (cured product in the laminate) thus obtained was measured and evaluated for each physical property. Table 1 shows results of the evaluation.

TABLE 1

| | Example | | | | | | | Comparative Example | | | |
|---|---|---|---|---|---|---|---|---|---|---|---|
| Composition (parts by mass) | 1 | 2 | 3 | 4 | 5 | 6 | 7 | 1 | 2 | 3 | 4 |

| | | | | | | | | |
|---|---|---|---|---|---|---|---|---|
| Composition | (A) | (A-1) | Unmodified bisphenol A | 55 | 35 | 55 | 55 | 35 |
| of curable | | | epoxy resin | | | | | |
| resin | | (A-2) | Unmodified bisphenol F | | 20 | | | |
| composition | | | epoxy resin | | | | | |
| | | (A-3) | Aliphatic polybasic acid- | | | | | 20 |
| | | | modified epoxy resin | | | | | |
| | | | Rubber-modified epoxy | | | | 75 | 75 |
| | | | resin | | | | | |

| (A) + (C) | Dispersion (M) in which | 75 | 75 | 75 | | |
|---|---|---|---|---|---|---|
| | component (C) was | | | | | |
| | dispersed in component (A) | | | | | |
| (B) | Dicyandiamide | 7 | 7 | 7 | 7 | 7 |
| (D) | Curing accelerator | 2 | 2 | 2 | 2 | 2 |

| | | | | | |
|---|---|---|---|---|---|
| Fumed silica | 6 | 6 | 6 | 6 | 6 |
| Non-treated ground | 60 | 60 | 60 | 60 | 60 |
| calcium carbonate | | | | | |
| Calcium oxide | 1.5 | 1.5 | 1.5 | 1.5 | 1.5 |

| | | | | | |
|---|---|---|---|---|---|
| Amount of component (B) with | 7 parts | 7 parts | 7 parts | 5 parts | 5 parts |
| respect to 100 parts by mass of | | | | | |
| component (A) (parts by mass) | | | | | |
| Amount of component (C) with | 30 parts | 30 parts | 30 parts | 0 parts | 0 parts |
| respect to 100 parts by mass of | | | | | |
| component (A) (parts by mass) | | | | | |
| Amount of component (D) with | 2 parts | 2 parts | 2 parts | 2 parts | 2 parts |
| respect to 100 parts by mass of | | | | | |
| component (A) (parts by mass) | | | | | |
| Amount of component (A-1) in | 100% | 80% | 100% | 42% | 27% |
| component (A) (% by mass) | | | | | |

| | | | Example | | | | | | | Comparative Example | | | |
|---|---|---|---|---|---|---|---|---|---|---|---|---|---|
| | | | 1 | 2 | 3 | 4 | 5 | 6 | 7 | 1 | 2 | 3 | 4 |
| Thickness | (X) | Average thickness of | 1.6 | 0.8 | 1.05 | 0.5 | 0.5 | 0.5 | 0.5 | 1.6 | 1.6 | 1.6 | 0.5 |
| of each | | adherends (mm) | | | | | | | | | | | |
| part of | | Thickness of first | 1.6 | 0.8 | 1.6 | 0.5 | 0.5 | 0.5 | 0.5 | 1.6 | 1.6 | 1.6 | 0.5 |
| laminate | | adherend (mm) | | | | | | | | | | | |
| | | Thickness of second | 1.6 | 0.8 | 0.5 | 0.5 | 0.5 | 0.5 | 0.5 | 1.6 | 1.6 | 1.6 | 0.5 |
| | | adherend (mm) | | | | | | | | | | | |
| | (Y) | Thickness of cured | 0.85 | 0.69 | 1.25 | 0.36 | 0.49 | 1.21 | 0.50 | 0.26 | 0.37 | 1.13 | 0.40 |
| | | product (mm) | | | | | | | | | | | |
| | (Y/X) | Ratio of thickness | 0.53 | 0.86 | 1.19 | 0.72 | 0.98 | 2.42 | 1.00 | 0.16 | 0.23 | 0.71 | 0.80 |
| | | of cured product and | | | | | | | | | | | |
| | | average thickness | | | | | | | | | | | |
| | | of adherends | | | | | | | | | | | |

| Curing | Curing temperature | 130° C. | | | | | | | 130° C. | | | |
|---|---|---|---|---|---|---|---|---|---|---|---|---|
| condition | Curing time | 20 min | | | | | | | 20 min | | | |
| Physical | Glass transition temperature | 123 | 128 | 129 | 129 | 130 | 131 | 123 | 107 | 119 | 101 | 67 |
| properties | (Tg1) of cured product (° C.) | | | | | | | | | | | |
| of cured | Storage modulus of cured | 2.23 | 2.12 | 2.16 | 2.14 | 2.43 | 2.41 | 2.35 | 2.16 | 2.31 | 1.39 | 0.79 |
| product | product at 23° C.: E′ (GPa) | | | | | | | | | | | |
| | Storage modulus of cured | 1.30 | 1.40 | 1.45 | 1.45 | 1.50 | 1.64 | 1.29 | 0.20 | 1.04 | 0.39 | 0.001 |
| | product at 100° C.: E′ (GPa) | | | | | | | | | | | |
| | Storage modulus of cured | 0.11 | 0.32 | 0.41 | 0.44 | 0.46 | 0.61 | 0.14 | 0.015 | 0.059 | 0.007 | 0.001 |
| | product at 120° C.: E′ (GPa) | | | | | | | | | | | |
| | Glass transition temperature | 151 | | | | | | 147 | 151 | | 139 | 115 |
| | (Tg2) of cured product | | | | | | | | | | | |
| | obtained by curing at 130° C. | | | | | | | | | | | |
| | for 120 minute (° C.) | | | | | | | | | | | |
| | Achievement ratio (Tg1/Tg2) of | 82% | 85% | 86% | 85% | 86% | 87% | 84% | 71% | 79% | 72% | 58% |
| | glass transition temperature (%) | | | | | | | | | | | |

One or more embodiments of the present invention can provide a method for producing a laminate that is obtained by bonding an adherend with use of a cured product which has a high elastic modulus in a high-temperature environment even in a case where curing is carried out at a low temperature in a short time. This production method can be suitably applied to adhesion of steel plates, CFRP, aluminum plates, and concrete. One or more embodiments of the present invention thus can be suitably applied in vehicle, aircraft, aerospace, mechanical, electrical, construction, and civil engineering fields.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A method for producing a laminate, comprising the steps of:
(i) applying a curable resin composition to a first adherend and bonding a second adherend with the first adherend; and
(ii) curing the curable resin composition,
wherein in the step (ii), the curable resin composition is cured at a temperature of 105° C. to 145° C.,
in the step (ii), the curable resin composition is cured for 10 minutes to 60 minutes,
the laminate comprises the first adherend, a cured product obtained by curing the curable resin composition, and the second adherend layered in this order,
the curable resin composition contains:
an epoxy resin (A); and
dicyandiamide (B) in an amount of 3.5 parts by mass to 19.0 parts by mass with respect to 100 parts by mass of the epoxy resin (A),
the epoxy resin (A) contains an unmodified bisphenol A epoxy resin (A-1) in an amount of 51% by mass to 100% by mass in 100% by mass of a total amount of the epoxy resin (A), and
a thickness (Y) of the cured product and an average thickness (X) of the first adherend and the second adherend is at a ratio (Y/X) of 0.5 to 10.0.

2. The method according to claim 1, wherein
an achievement ratio of glass transition temperature of the cured product is not less than 80%, and
the achievement ratio of glass transition temperature of the cured product is calculated according to the following expression:
the achievement ratio of glass transition temperature of the cured product=(glass transition temperature (Tg1) (° C.) in degrees Celsius of a cured product obtained by curing the curable resin composition at a curing temperature of 130° C. for a curing time of 20 minutes/glass transition temperature (Tg2) (C) in degrees Celsius of a cured product obtained by curing the curable resin composition at a curing temperature of 130° C. for a curing time of 120 minutes)×100.

3. The method according to claim 1, wherein the cured product has a storage modulus of not less than 1 GPa at 23° C., and the storage modulus is measured under a condition of a frequency of 1 Hz in a tensile mode of dynamic viscoelasticity measurement.

4. The method according to claim 1, wherein the cured product has a storage modulus of not less than 0.07 GPa at 120° C., and the storage modulus is measured under a condition of a frequency of 1 Hz in a tensile mode of dynamic viscoelasticity measurement.

5. The method according to claim 2, wherein the glass transition temperature (Tg1) of the cured product is not lower than 120° C.

6. The method according to claim 1, wherein the epoxy resin (A) does not contain an aliphatic polybasic acid-modified epoxy resin (A-3).

7. The method according to claim 1, wherein the epoxy resin (A) contains an aliphatic polybasic acid-modified epoxy resin (A-3) in an amount of more than 0% by mass and less than 3% by mass.

8. The method according to claim 1, wherein the first adherend or the second adherend or a combination of the first adherend and the second adherend is a steel sheet.

9. The method according to claim 1, wherein the curable resin composition further contains polymer particles (C) in an amount of 1 part by mass to 100 parts by mass with respect to 100 parts by mass of the epoxy resin (A), and the polymer particles (C) have a core-shell structure including a core layer and a shell layer.

10. The method according to claim 1, wherein the curable resin composition further contains a curing accelerator (D) in an amount of 0.1 parts by mass to 15 parts by mass with respect to 100 parts by mass of the epoxy resin (A).

11. The method according to claim 9, wherein the core layer contains at least one selected from the group consisting of diene-based rubbers, (meth)acrylate-based rubbers, and organosiloxane-based rubbers.

12. The method according to claim 9, wherein the core layer is made of butadiene rubber or butadiene-styrene rubber or a combination of the butadiene rubber and the butadiene-styrene rubber.

13. The method according to claim 9, wherein the shell layer contains a structural unit derived from at least one type of monomer selected from the group consisting of aromatic vinyl-based monomers, vinyl cyanide-based monomers, and (meth)acrylate-based monomers.

14. A method for producing a vehicle body structure, comprising the method of producing the laminate according to claim 1.
